(19) United States
(12) Patent Application Publication
(10) Pub. No.: US 2011/0198196 A1
(43) Pub. Date: Aug. 18, 2011

(54) DEVICE FOR CONVEYING AND/OR ACCUMULATING ARTICLES

(75) Inventor: LAURA ECKERT, Zeitlarn (DE)

(73) Assignee: KRONES AG, Neutraubling (DE)

(21) Appl. No.: 13/023,696

(22) Filed: Feb. 9, 2011

(30) Foreign Application Priority Data
Feb. 17, 2010 (DE) 102010002039.7

(51) Int. Cl. B65G 43/00; B65G 15/24

(52) U.S. Cl. 198/577; 198/606

(57) ABSTRACT

A device for conveying and/or accumulating articles, particularly packs, along a conveying section, and having at least two conveying elements, the conveying elements being configured as endless conveyors, particularly as belt conveyors, and a drive, the at least two conveying elements being drivable by the drive particularly independently of each other.

### CROSS-REFERENCE TO RELATED APPLICATION

The present application claims the benefit of priority of German Application No. 102010002039.7, filed Feb. 17, 2010. The entire text of the priority application is incorporated herein by reference in its entirety.

### FIELD OF THE DISCLOSURE

The present disclosure relates to a device for conveying and/or accumulating articles, particularly packs, along a conveying section.

### BACKGROUND

So-called accumulation conveyors are often used particularly in the beverage industry, the conveyors comprising a plurality of conveying elements along a conveying section. Each of the conveying elements normally comprises a drive of its own. Due to such a separate drive it is possible to drive each individual conveying element independently of the others. It is thereby possible to either move (convey) or stop (accumulate) an item to be conveyed that is arranged on a conveying element.

It is possible to configure the conveyor as a roller conveyor. In a roller conveyor individual rollers or segments of rollers can be driven and decelerated in any desired way within their degrees of freedom. With a strongly varying geometry and weight of the articles to be conveyed, at high conveying speeds, and/or in the case of quiet transportation, the use of the belt conveyor technique should however be preferred over the roller conveyor technique.

The known belt conveyors, however, have the drawback with respect to conveyance and/or accumulation that they require a great number of drives, a complicated electrical connection, a time-consuming starting, and great efforts as regards control engineering.

### SUMMARY OF THE DISCLOSURE

It is therefore an aspect of the present disclosure to provide a simplified device for conveying and/or accumulating articles.

The device according to the disclosure for conveying and/or accumulating articles, particularly packs, along a conveying section, comprises at least two conveying elements, the conveying elements being configured as endless conveyors, particularly as belt conveyors, and a drive, the at least two conveying elements being drivable by the drive particularly independently of each other.

Since not each of the conveying elements has a drive of its own, but the at least two conveying elements are drivable by one drive, a device as described above exhibits a simplified construction as compared with known devices.

Hence, it may be necessary to stop an article temporarily for a predetermined period of time. Here, one speaks about “accumulating” an article. Otherwise, the article can be moved along the conveying section. Here, one speaks about “conveying” an article.

The article to be conveyed or accumulated may be a beverage article or a food article. The article may also correspond to a pack. A pack may refer to the entity consisting of packaged good and packaging. To be more specific, a pack of a beverage article may correspond to a beverage and the associated packaging. A pack may also be a large pack comprising a plurality of individual packs. For instance, a pack may be a beverage crate with bottles filled with a beverage. A pack may also be a carton or a shrink pack. The packs may be packs of one or several beverage articles and/or foods, commercial products and/or containers and/or packets in general.

The conveying section may particularly be a section along which an article, particularly a pack, is to be conveyed. The conveying section may comprise at least two conveying elements, with the conveying elements being specifically arranged and/or configured such that an article, i.e. an item to be conveyed, can be moved by means of the conveying elements along the conveying section. In other words, the conveying section may be subdivided into conveying elements or conveying segments.

The conveying elements may be arranged in a row, each of the conveying elements having the same conveying direction. The conveying elements or conveying segments can particularly be arranged directly one after the other.

The conveying elements or conveying segments may be configured as belt conveyors. In a belt conveyor an endless band or belt is driven via at least two deflection pulleys. Instead of the belt, it is also possible to use a chain-link mat or another endless conveyor band similar to the belt in its mode of operation.

The drive may be a motor, particularly an electric motor. The drive may be configured such that it provides enough drive power so as to drive the at least two conveying elements at the same time.

The device may further include a transmission element for transmitting drive power from the drive to the conveying elements. The transmission element may particularly comprise a belt, a chain and/or a shaft. A belt is particularly advantageous for a simple construction. The transmission element may also comprise a plurality of belts, chains and/or shafts.

Each of the at least two conveying elements may be connectable via a clutch to the transmission element. In other words, for each conveying element the device can comprise a clutch via which the conveying element can be connected to the transmission element. The drive power of the drive can be passed on to the conveying element via the transmission element and the clutch, and the conveying element can thus be put in motion. The clutch can also be used for decoupling a conveying element from the transmission element. In this case the conveying element is not driven. This permits accumulation (stoppage) of an item to be conveyed that is positioned on the conveying element.

The device can particularly be configured such that each of the at least two conveying elements can be connected via the clutch to the transmission element or can be separated from the transmission element, the at least two conveying elements remaining stationary in this instance. Hence, one need not change the conveying elements in their relative position in order to connect them to the transmission element or to separate them from the transmission element. As a result, the device can be made compact, i.e. space-saving.

The clutch of a conveying element can be connected to one of the deflection pulleys of the conveying element. The deflection pulley can thereby be configured as a drive roll.

The clutch may particularly be a magnetic particle clutch or an electromagnetic clutch.

The clutch can be combined as a clutch/brake combination with a brake function. A brake function can control a positioning of the item to be conveyed during conveyance and/or accumulation, such positioning being as exact as possible.

The device can further comprise a control element for controlling the coupling and/or decoupling of the conveying elements.

To be more specific, all of the conveying elements of the conveying section are driven by the drive, particularly independently of one another. In other words, the drive may be a central drive which makes it possible to drive the individual conveying elements via the transmission element. Each individual conveying element can be connected via a clutch to the transmission element and thus switched to the central drive or again separated from the drive.

The device may also comprise at least four conveying elements, the drive being a first drive, and the device further comprising a second drive, wherein at least two conveying elements are drivable by the first drive, particularly independently of each other, and at least two conveying elements are drivable by the second drive, particularly independently of each other. Especially with long units, for instance devices having four or more conveying elements, the load may be too much for a transmission element, for instance a belt. The load can be halved by providing two drives.

For instance, the conveying elements can be assigned to the first or the second drive alternatively or alternatingly.

### BRIEF DESCRIPTION OF THE DRAWINGS

Further features and advantages will be explained hereinafter with reference to the exemplary figures, in which:

FIG. 1 is an illustration of an exemplary device for conveying and/or accumulating articles;

FIG. 2 is an illustration of a second exemplary device for conveying and/or accumulating articles; and

FIG. 3 is an illustration of a third exemplary device for conveying and/or accumulating articles.

### DETAILED DESCRIPTION OF THE PREFERRED EMBODIMENT

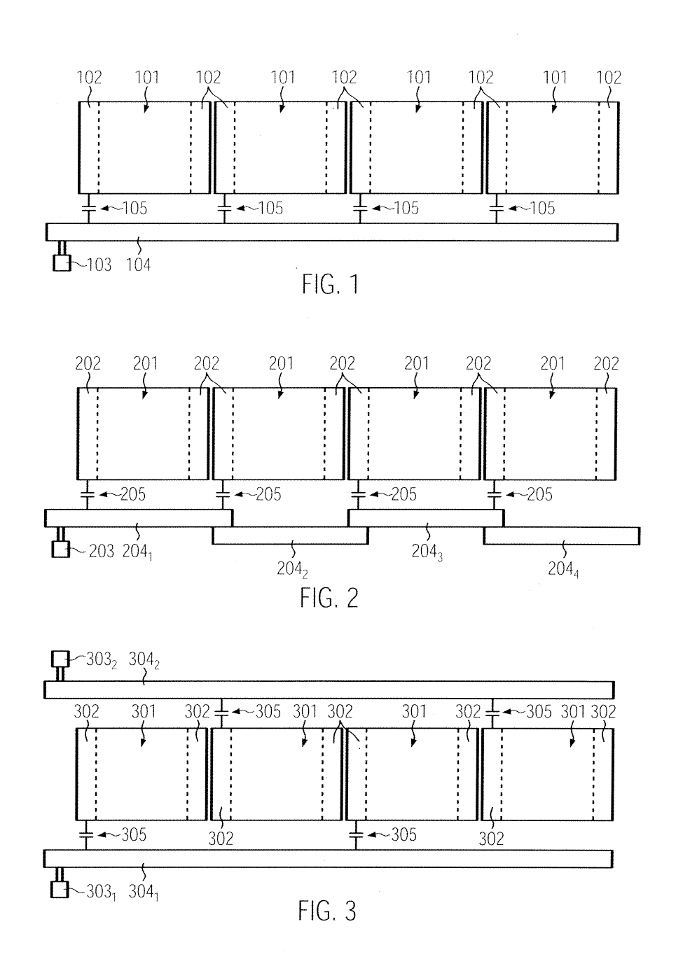

FIG. 1 shows four conveying elements arranged in a row. Said four exemplary conveying elements make up part of a conveying section. Each of the conveying elements is configured as a belt type accumulation conveyor. In other words, each of the conveying elements comprises an endless belt 101 which can be moved via deflection pulleys 102.

Furthermore, FIG. 1 shows a motor 103 which is configured as a drive for the conveying elements. Particularly, the motor 103 is connected to a belt 104 which transmits the drive power to the conveying elements. A clutch 105 is provided for each of the conveying elements, the clutches being adapted to be connected to the belt 104 independently of one another or adapted to be separated from the belt 104 again. When the belt 104 is in motion, the conveying elements, particularly the one deflection pulley 102 configured as the drive roll, can be driven or stopped, respectively, via the clutch 105. It is thereby also possible to either move (convey) or stop (accumulate) an item to be conveyed that is positioned on a belt 101.

A control logic implemented in a superior control element can control the coupling and decoupling of the conveying elements. A control element that centrally controls a plurality of conveying elements or groups of conveying elements or a conveying system, but also a control unit that decentrally controls an individual conveying element on the basis of the states of neighboring conveying elements from a system view can be regarded as the superior control element.

Since a motor 103 is provided, the efforts in terms of material and control engineering can be reduced in comparison with known systems in which each of the conveying elements has a motor of its own. This may have a positive effect both on the costs and environmental compatibility of such a system.

FIG. 2 shows another example of such a device for conveying and/or accumulating articles. Like the example given in FIG. 1, the device shown in FIG. 2 comprises four conveying elements that are drivable independently of each other, each of the conveying elements comprising a belt 201 and two deflection pulleys 202. Moreover, FIG. 2 shows a motor 203 which is connected to a transmission element. In contrast to the transmission element of FIG. 1, the transmission element of FIG. 2 comprises four belts 204₁, 204₂, 204₃ and 204₄. Two of the belts 204₁ and 204₃ can be connected via clutches 205 to the conveying elements. The belts 204₂ and 204₄ are connected to the belt 204₁ and 204₃, respectively. Such a construction may be advantageous due to the usability of shorter belts with power transmission via a shaft.

FIG. 3 shows a further exemplary device for conveying and/or accumulating articles. The device comprises four conveying elements, of which each comprises a belt 301 and deflection pulleys 302. One of the deflection pulleys 302 serves as a drive roll and is connectable via a clutch 305 to a transmission element 304₁ and 304₂, respectively. In contrast to the examples that have been shown before, the example illustrated in FIG. 3 shows two motors 303₁ and 303₂, of which two conveying elements can be driven independently of each other via a respective belt 304₁ and 304₂, respectively, and can be driven via the clutches 305 independently of one another. The conveying elements are particularly alternatingly connected either to the first belt 304₁ or to the second belt 304₂. The load can be distributed over two belts and/or two motors by providing two drives.

It goes without saying that features mentioned in the previously described embodiments are not limited to these special combinations and are also possible in any other combinations. Particularly, the device can be used for conveying and/or accumulating packs in the beverage industry or also for the packaged transportation of consumer goods or in distribution centers of mail-order companies.

1. A device for conveying and/or accumulating articles, particularly packs, along a conveying section, comprising:
at least two conveying elements, the conveying elements being configured as endless conveyors; and
a drive, the at least two conveying elements being drivable by the drive.

2. The device according to claim 1, and a transmission element for transmitting a drive power from the drive to the conveying elements.

3. The device according to claim 2, wherein the transmission element comprises a belt, and a chain, a shaft, or a combination thereof.

4. The device according to claim 2, wherein each of the at least two conveying elements is connectable via a clutch to the transmission element.

5. The device according to claim 4, and a control element for controlling the coupling and/or decoupling of the conveying elements.

6. The device according to claim 4, wherein the clutch is one of a magnetic particle clutch or an electromagnetic clutch.

7. The device according to claim 4, wherein the clutch is combined as a clutch/brake combination with a brake function.

8. The device according to claim 1 any one of the preceding claims, wherein all of the conveying elements of the conveying section are drivable by the drive.

9. The device according to claim 1, and comprising at least four conveying elements, wherein the drive is a first drive, and wherein the device further comprises a second drive, wherein at least two conveying elements are drivable by the first drive, and at least two conveying elements are drivable by the second drive.

10. The device according to claim 1, wherein the endless conveyors are belt conveyors.

11. The device according to claim 1, wherein the at least two conveying elements are drivable by the drive independently of each other.

12. The device according to claim 8, wherein all of the conveying elements of the conveying section are drivable by the drive independently of one another.

13. The device according to claim 9, wherein the at least two conveying elements drivable by the first drive are driven independently of each other.

14. The device according to claim 9, and wherein the at least two conveying elements driven by the second drive are driven independently of each other.
